(19) United States
(12) Patent Application Publication
(10) Pub. No.: US 2022/0306313 A1
(43) Pub. Date: Sep. 29, 2022

(54) FLIGHT DECK SYSTEM FOR DETERMINING AIRCRAFT OPERATING CONSTRAINTS

(71) Applicant: Garmin International, Inc., Olathe, KS (US)

(72) Inventors: Robert W. Gaul, Olathe, KS (US); Gene L. Field, Linwood, KS (US); Michael J. Peuser, Paola, KS (US); Carl D. Strickland, Chandler, AZ (US)

(21) Appl. No.: 17/209,988

(22) Filed: Mar. 23, 2021

(51) Int. Cl. B64D 43/02; G01C 23/00; G08G 5/00

(52) U.S. Cl. CPC B64D 43/02; G01C 23/005; G08G 5/0021

(57) ABSTRACT

A flight deck system for an aircraft includes a processor, a graphical interface for displaying flight-related information in the form of operating criteria corresponding to a flight chart associated with an aircraft, a control interface for receiving information from the pilot and allowing the pilot to interact with the graphical interface, and a non-transitory computer-readable storage medium for storing a database related to the flight chart. The database includes a waypoint associated with the chart and an operating constraint associated with the waypoint. The processor is operable to receive a target operating parameter associated with the aircraft and select an applicable waypoint and corresponding operating constraint from the database. The processor is further operable to compare the target operating parameter with the corresponding operating constraint and, based on the comparison, display the target operating parameter and a corresponding operating constraint indicator on the graphical interface.

### BACKGROUND

In aviation, a waypoint is a predetermined geographical position that is defined in terms of latitude/longitude coordinates. Waypoints may be a simple named point in space or may be associated with existing navigational aids, intersections, or fixes. A waypoint can be used to indicate a change in direction, speed, or altitude along the desired path.

### DRAWINGS

The Detailed Description is described with reference to the accompanying figures. The use of the same reference numbers in different instances in the description and the figures may indicate similar or identical items.

FIG. 1 is block diagram illustrating a flight deck system for displaying flight-related information for an aircraft, where the flight deck system is configured to receive an applicable waypoint, identify a corresponding target operating parameter and/or operating constraint based upon the waypoint, and display an applicable operating constraint indicator in accordance with example embodiments of the present disclosure.

FIG. 2 is an illustration depicting a representative example instrument panel of an aircraft including a flight deck system, such as the flight deck system illustrated in FIG. 1, in accordance with an example embodiment of the present disclosure.

FIG. 3 is a diagrammatic illustration of a flight chart for providing flight-related information to a flight deck system, such as the flight deck system illustrated in FIG. 1, in accordance with an example embodiment of the present disclosure.

FIG. 4 is another diagrammatic illustration of a flight chart for providing flight-related information to a flight deck system, such as the flight deck system illustrated in FIG. 1, in accordance with an example embodiment of the present disclosure.

FIG. 5A is a diagrammatic illustration of a graphical interface, where flight-related information for an aircraft is displayed in accordance with an example embodiment of the present disclosure.

FIG. 5B is another diagrammatic illustration of the graphical interface illustrated in FIG. 5A.

FIG. 5C is another diagrammatic illustration of the graphical interface illustrated in FIG. 5A.

FIG. 5D is another diagrammatic illustration of the graphical interface illustrated in FIG. 5A.

FIG. 6 is another diagrammatic illustration of a graphical interface, where flight-related information for an aircraft is displayed in accordance with an example embodiment of the present disclosure.

### DETAILED DESCRIPTION

A flight deck system can include electronic devices, such as integrated avionics systems, which are utilized by one or more aircraft operators (e.g., a pilot and/or a co-pilot) to navigate an aircraft. Integrated avionics systems may employ primary flight display(s) (PFDs), multifunction display(s) (MFDs), and electronic flight bags (EFBs) to furnish primary flight control, navigational, and other information to the flight crew of the aircraft. Additionally, the integrated avionics systems may also employ an avionics control and display unit (CDU), portable electronic devices (PEDs), applications, and/or other control devices that are configured to provide control functionality to the PFDs, the MFDs, and/or the EFBs.

There is a recognized need to provide the operator (e.g., pilot or co-pilot) with increased automation of aircraft operations. Aircraft operations requiring significant manual control and/or significant manual data entry are inefficient, increase heads-down time, and increase the risk of operator error. For example, operating constraints associated with aeronautical chart (e.g., flight chart) waypoints are not readily displayed for the pilot without manual data selection/data entry. For efficiency and/or safety of operation, it may be beneficial to provide such necessary flight information to the operator through an accessible and user-friendly interface.

Accordingly, flight deck systems and methods for operating flight deck systems for controlling an aircraft are described. In an embodiment, a flight deck system (e.g., integrated avionics system) for an aircraft includes a processor, a graphical interface for displaying flight-related information in the form of operating criteria corresponding to a flight plan and/or flight chart(s) associated with an aircraft, a control interface for receiving information from the pilot and allowing the pilot to interact with the graphical interface, and a non-transitory computer-readable storage medium for storing a database related to the flight chart. The database includes a waypoint(s) associated with the chart and an operating constraint(s) associated with the waypoint. The non-transitory computer-readable storage medium has computer executable instructions stored thereon for execution by the processor to receive, via the control interface, a target operating parameter(s) associated with the aircraft, and to select, from the database, an applicable waypoint and corresponding operating constraint (e.g., speed constraint). The processor is operable to compare the target operating parameter with the corresponding operating constraint (e.g., speed constraint). The processor is further operable to display an operating constraint indicator on the graphical interface based on the comparison of the target operating parameter and the corresponding one of the at least one operating constraint.

A method of operating a flight deck system of an aircraft, includes receiving, via a control interface, a target operating parameter associated with the aircraft; and selecting, from a database of information related to a flight chart associated with the aircraft stored by the non-transitory computer-readable storage medium, one of a plurality of waypoints associated with the flight chart and a corresponding operating constraint(s) associated with the plurality of waypoints. The target operating parameter is compared with the corresponding operating constraint(s), and an operating constraint indicator is displayed, via a graphical interface, based on the comparison between the target operating parameter and the corresponding operating constraint.

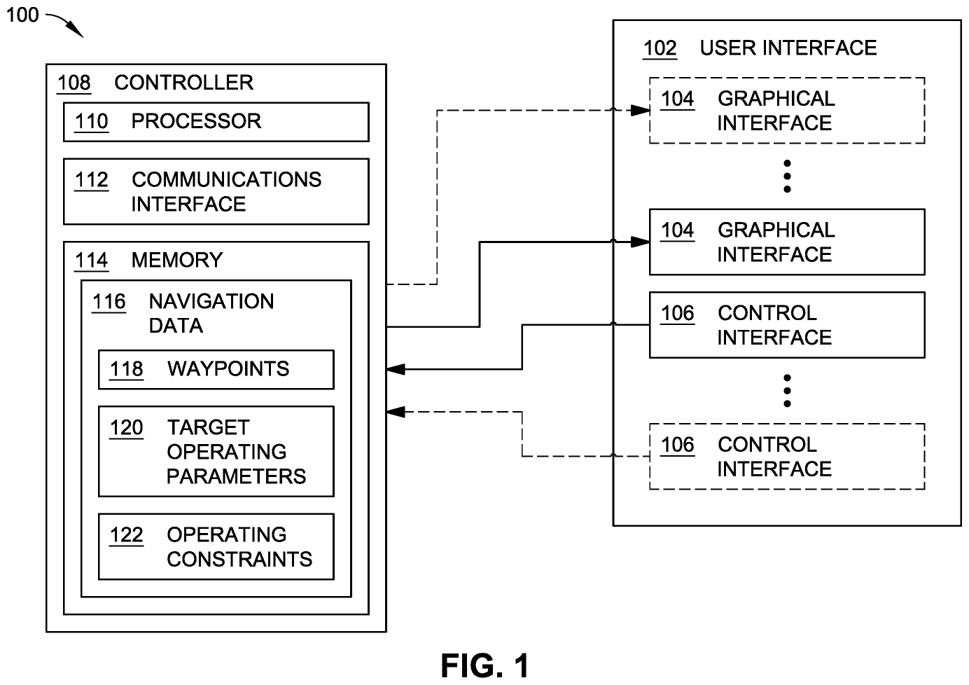

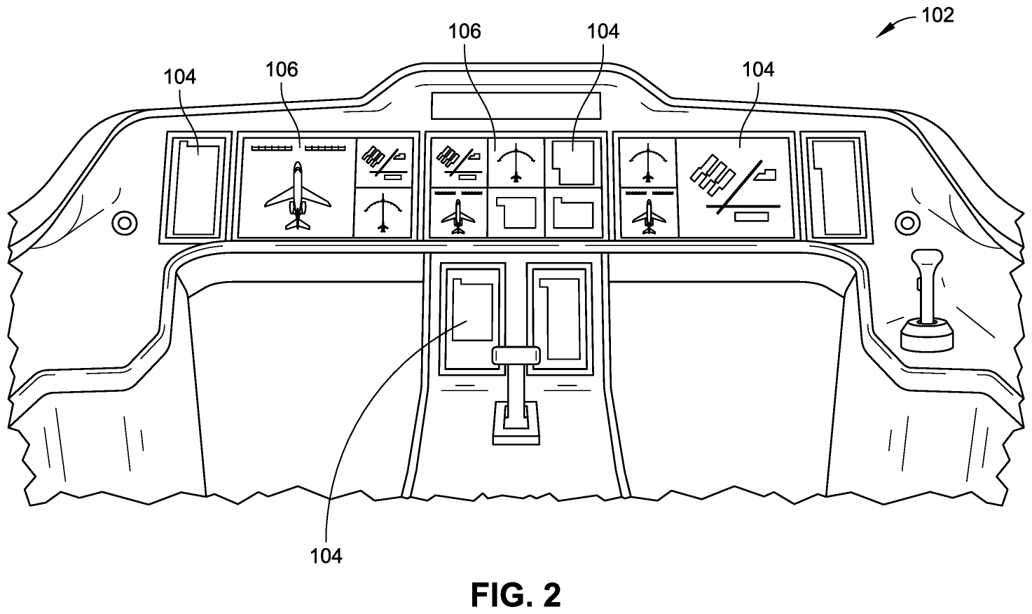

FIGS. 1 and 2 illustrate an example embodiment of a flight deck system (e.g., integrated avionics system 100) within an aircraft. The integrated avionics system 100 generally includes a user interface 102 having a graphical interface 104 and a control interface 106. The integrated avionics system 102 also includes a controller 108 having a processor 110, a communications interface 112, and a non-transitory computer-readable storage medium (e.g., memory 114).

The graphical interface 104 includes a display, such as an LCD (Liquid Crystal Diode) display, a TFT (Thin Film Transistor) LCD display, an LEP (Light Emitting Polymer) or PLED (Polymer Light Emitting Diode) display, and so forth, configured to display text and/or graphical information on a display screen. The display screen can be backlit via a backlight such that it can be viewed in the dark or other low-light environments. In some embodiments, the graphical interface 104 can be disposed on an instrument panel of the aircraft, a pedestal area of the aircraft, an outboard area of the aircraft, and so forth. In embodiments, the integrated avionics system 100 can include one or more graphical interfaces 104 with corresponding displays for providing differing functionality including, but not limited to: PFD(s), MFD(s), head up display(s) (HUDs), secondary display unit(s) (SDUs), CDU(s), PED(s), EFBs, and so forth. The graphical interfaces 104 may furnish a general-purpose pilot interface to control the aircraft's avionics. For example, the graphical interfaces 104 allow the pilot to control various systems of the aircraft such as the aircraft's flight management system, autopilot system, navigation systems, communication systems (e.g., controller pilot data link communications system [CDPLC], automatic dependent surveillance-broadcast [ADS-B], aircraft communications addressing and reporting system [ACARS], airborne satellite communications systems [SATCOM], other data link systems, other ground-ground communication systems, etc.), engines, and so on, via the avionics data bus. In implementations, the avionics data bus may include a high-speed data bus (HSDB), such as data bus complying with ARINC 429 data bus standard promulgated by the Airlines Electronic Engineering Committee (AEEC), a MIL-STD-1553 compliant data bus, and so forth.

The control interface 106 can be coordinated with the graphical interface 104 for entry of data and commands. In embodiments including a touch screen interface, the operator may use his or her fingers to manipulate images and/or selectable items on the graphical interface 104. The control interface 106 can be disposed on the graphical interface 104, external to the graphical interface 104, or a combination thereof. In some embodiments, the graphical interface 104 is operable by a combination of direct touch received via the touch screen interface and input received external to the graphical interface 104.

In embodiments including a touch screen interface, the control interface 106 includes a touch surface. For example, the touch surface can be a resistive touch screen, a surface acoustic wave touch screen, a capacitive touch screen, an infrared touch screen, optical imaging touch screens, dispersive signal touch screens, acoustic pulse recognition touch screens, combinations thereof, and the like. Capacitive touch screens can include surface capacitance touch screens, projected capacitance touch screens, mutual capacitance touch screens, and self-capacitance touch screens. In implementations, the touch surface is configured with hardware to generate a signal to send to a processor and/or driver upon detection of touch information (e.g., a touch input). As indicated herein, touch inputs include inputs, gestures, and movements where the input contacts the touch surface. In embodiments, the control interface 106 can receive touch information from an operator (e.g., user such as a pilot and/or a co-pilot) to interact with the graphical interface 104 displayed on the display screen. In some embodiments, the graphical interface 104 may include both active portions (e.g., areas that are responsive to operator touch information) and non-active portions (e.g., areas that are not responsive to operator touch information). In implementations, keyboards, cursors, buttons, softkeys, keypads, knobs and so forth, may be used for entry of data and commands instead of or in addition to the touch surfaces.

In embodiments, the graphical interface 104 is configured for displaying flight information. In some embodiments, the flight information includes information related to a flight plan and/or flight charts for the aircraft. As described below, flight information can include operating criteria for the aircraft (e.g., a target operating parameter, an operating restriction, etc.) associated with the flight plan. In some embodiments, the flight-related information is displayed in one or more primary flight windows (PFWs), one or more multifunction windows (MFWs), or a combination thereof. The PFWs may be configured to display primary flight information, such as aircraft attitude, altitude, heading, vertical speed, and so forth. In embodiments, the PFWs may display primary flight information via a graphical representation of basic flight instruments such as an attitude indicator, an airspeed indicator, an altimeter, a heading indicator, a course deviation indicator, and so forth. The PFWs may also display other flight-related information providing situational awareness to the pilot such as terrain information, ground proximity warning information, weather information, and so forth.

In embodiments, the MFWs display interactive flight-related information describing operation of the aircraft such as navigation routes, moving maps, engine gauges, weather radar, terrain alerting and warning system (TAWS) displays, ground proximity warning system (GPWS) displays, traffic collision avoidance system (TCAS) displays, airport information, and so forth, that are received from a variety of aircraft systems via the avionics data bus and/or are self-contained within the user interface 102. In some embodiments, the PFW may provide the functionality of an MFW. Where the system 100 includes multiple MFWs, MFWs that control a common systemwide value/state can be cross-filled when multiple instances viewing this value are active substantially simultaneously. Further, the graphical interface 104 may be capable of displaying multiple instances of the same application in multiple MFWs, for example, with no restrictions on the number of the same application that could be displayed substantially simultaneously. In some embodiments, MFWs and/or PFWs shall support display and/or control of third-party applications (e.g., video, hosted applications, mobile device applications, ARINC 661, etc.).

The controller 108 provides functionality to the user interface 102 via the processor 110, the communications interface 112, and the memory 114. The processor 110 can be operably and/or communicatively coupled with the graphical interface 104 and/or the control interface 106. The processor 110 can control the components and functions of the system 100 described herein using software, firmware, hardware (e.g., fixed logic circuitry), manual processing, or a combination thereof. The terms “controller,” “functionality,” “service,” and “logic” as used herein generally represent software, firmware, hardware, or a combination of software, firmware, or hardware in conjunction with controlling the system 100. In the case of a software implementation, the module, functionality, or logic represents program code that performs specified tasks when executed on a processor (e.g., central processing unit (CPU) or CPUs). The program code can be stored in one or more computer-readable memory devices (e.g., internal memory and/or one or more tangible media), and so on. The structures, functions, approaches, and techniques described herein can be implemented on a variety of commercial computing platforms having a variety of processors.

The processor 110 provides processing functionality for the system 102 and can include any number of processors, micro-controllers, or other processing systems, and resident or external memory for storing data and other information accessed or generated by the system 100. The processor 110 can execute one or more software programs that implement techniques described herein. The processor 110 is not limited by the materials from which it is formed, or the processing mechanisms employed therein and, as such, can be implemented via semiconductor(s) and/or transistors (e.g., using electronic integrated circuit (IC) components), and so forth.

The communications interface 112 is operatively configured to communicate with components of the system 100. For example, the communications interface 112 can be configured to transmit data for storage in the system 100, retrieve data from storage in the system 100, and so forth. The communications interface 112 is also communicatively coupled with the processor 110 to facilitate data transfer between components of the system 100 and the processor 110 (e.g., for communicating inputs to the processor 110 received from a device communicatively coupled with the system 100). It should be noted that while the communications interface 112 is described as a component of a system 100, one or more components of the communications interface 112 can be implemented as external components communicatively coupled to the system 100 via a wired and/or wireless connection. The system 100 can also include and/or connect to one or more input/output (I/O) devices (e.g., via the communications interface 112), including, but not necessarily limited to: a display, a mouse, a touchpad, a keyboard, and so on.

The communications interface 112 and/or the processor 110 can be configured to communicate with a variety of different networks, including, but not necessarily limited to: ARINC 429; RS-232; RS-422; CAN Bus; ARINC 661; a wide-area cellular telephone network, such as a 3G cellular network, a 4G cellular network, a 5G cellular network, or a global system for mobile communications (GSM) network; a wireless computer communications network, such as a Wi-Fi network (e.g., a wireless local area network (WLAN) operated using IEEE 802.11 network standards); an internet; the Internet; a wide area network (WAN); a local area network (LAN); a personal area network (PAN) (e.g., a wireless personal area network (WPAN) operated using IEEE 802.15 network standards); a public telephone network; an extranet; an intranet; and so on. However, this list is provided by way of example only and is not meant to limit the present disclosure. Further, the communications interface 112 can be configured to communicate with a single network or multiple networks across different access points.

The memory 114 is an example of tangible, computer-readable storage medium that provides storage functionality to store various data associated with operation of the system 100, such as software programs and/or code segments, or other data to instruct the processor 110, and possibly other components of the system 100, to perform the functionality described herein. Thus, the memory 114 can store data, such as a program of instructions for operating the system 100 (including its components), and so forth. It should be noted that while a single memory 114 is described, a wide variety of types and combinations of memory (e.g., tangible, non-transitory memory) can be employed. The memory 114 can be integral with the processor 110, can include stand-alone memory, or can be a combination of both.

The memory 114 can include but is not necessarily limited to: removable and non-removable memory components, such as random-access memory (RAM), read-only memory (ROM), flash memory (e.g., a secure digital (SD) memory card, a mini-SD memory card, and/or a micro-SD memory card), magnetic memory, optical memory, universal serial bus (USB) memory devices, hard disk memory, external memory, and so forth. In implementations, the system 100 and/or the memory 114 can include removable integrated circuit card (ICC) memory, such as memory provided by a subscriber identity module (SIM) card, a universal subscriber identity module (USIM) card, a universal integrated circuit card (UICC), and so on. In embodiments, the memory 114 includes one or more software modules capable of being executed by the processor 110, and one or more data sets and/or databases. In embodiments, the memory 114 includes one or more software modules capable of being executed by the processor 110, and one or more data sets and/or databases.

The memory 114 is operable to store a database of flight-related information associated with a flight plan and/or flight charts for an aircraft. In some embodiments, flight-related information includes electronic representations of and/or information obtained from flight charts (e.g., instrument approach charts, airport diagrams, departure procedure charts, standard terminal arrival charts, charted visual flight procedure charts, etc.) describing procedures and information for operating the aircraft. For example, each flight chart is described by navigation data 116 for operating the aircraft. Navigational data 116 can include one or more waypoints 118 and related operating constraints 122 (e.g., speed constraints, altitude constraints, etc.) associated with the aircraft. Waypoints 118 include geographical passage points for the aircraft in a horizontal plane, with which are associated possible constraints (e.g., altitude constraints, speed constraints, time constraints, etc.). In a specific embodiment, each speed and/or altitude constraint may define a speed and/or altitude above, below, or at which the aircraft has to fly at the given waypoint 118. Each speed and/or altitude constraint is thus associated with a speed or altitude, respectively, above (“ABOVE constraint”), below (“BELOW constraint”), between (“BETWEEN constraint”), or through (“AT constraint”) which the aircraft must pass. Of course, embodiments of the present invention may utilize any type of constraint comparison. It is to be understood that while certain operating constraints (e.g., speed, altitude, etc.) are described herein, navigation data 122 can include additional data related to the operation of the aircraft and/or related to the surrounding environment (e.g., navigation obstacle, circling approach obstacle, etc.). It is to be understood that the terminology “information associated with the aircraft” also includes both information associated with the aircraft and information associated with the related environment.

The navigation data 116 associated with the aircraft or environment can be received from a variety of sources. In some embodiments, the waypoints 118, and/or operating constraints 122 can be manually entered by the pilot via the control interface 106. In some embodiments, the navigation data 116 associated with the aircraft is received directly from an aircraft system or instrument including, but not limited to basic aircraft instruments (e.g., altitude indicator, an airspeed indicator, an altimeter, a heading indicator, a course deviation indicator, etc.), aircraft warning systems (e.g., TAWS, TCAS, GPWS, etc.), aircraft control systems (e.g., flight management system, autopilot system, navigation systems, communication systems, etc.), aircraft information systems (e.g., air data computers, etc.) and so forth. It is further contemplated that the system 100 can include one or more sensors for providing navigation data 116 to the aircraft via the controller 108.

In embodiments, navigation data 116 can also include one or more operating constraints 122 corresponding to the waypoints 118. In embodiments, operating constraints 122 can be described as restraints or limits on operating parameters (e.g., aircraft speed, aircraft altitude, etc.) associated with the aircraft. For example, a BELOW speed constraint may require the aircraft to operate below a designated speed at the associated waypoint 118. In some embodiments, operating constraints 122 function as restraints on target operating parameter(s) 120 associated with the aircraft (e.g., target speed, target altitude, etc.). For example, a BELOW speed constraint may require the aircraft to operate below a preselected target speed at the associated waypoint 118. Target operating parameters 120 can be determined from factors associated with the aircraft such as configuration of the aircraft, weight of the aircraft, and/or settings of aircraft systems; and can be received from a variety of sources. In some embodiments, the target operating parameter 120 can be manually entered by the pilot via the control interface 106. In some embodiments, the target operating parameter 120 is received directly from an aircraft system or instrument including, but not limited to basic aircraft instruments (e.g., altitude indicator, an airspeed indicator, an altimeter, a heading indicator, a course deviation indicator, etc.), aircraft warning systems (e.g., TAWS, TCAS, GPWS, etc.), aircraft control systems (e.g., flight management system, autopilot system, navigation systems, communication systems, etc.), aircraft information systems (e.g., air data computers, etc.) and so forth. For example, a target speed can be obtained from the flight management system. It is contemplated that, in some embodiments, target operating parameters 120 of the aircraft are storable via the memory 114 and available for future use. In other embodiments, target operating parameters 120 may be stored by and/or retrieved from other aircraft systems or instrumentation.

Still referring to FIGS. 1 and 2, the processor 110 is operable to select applicable waypoints 118 associated with the flight plan. For example, the processor 110 is operable to retrieve from memory 114 an applicable waypoint(s) 118. In some embodiments, the processor 110 is operable to determine applicable waypoints 118 based on a geographic position of the aircraft. For example, the processor 118 may identify a next downstream waypoint 118 associated with the aircraft. In some embodiments, the processor 110 utilizes a real-time position of the aircraft to determine the applicable waypoint(s) 118. For example, the processor 110 receives via the controller 108, a real-time geographical position associated with the aircraft (e.g., from a navigation system, flight management system, or other aircraft system), and determines an applicable downstream waypoint 118 associated with the aircraft's position.

The processor 110 is further operable to select applicable operating constraint(s) 122 corresponding to the applicable waypoints 118. For example, based on the stored navigation data 116, the processor 110 can identify an ABOVE, BELOW, BETWEEN, or AT constraint on aircraft speed and/or aircraft altitude at the applicable waypoint 118. In some embodiments, the processor 110 is operable to identify other applicable operating constraint(s) 122 corresponding to the target operating parameters 120 based on the flight plan. For example, the flight plan may include speed constraints associated with the altitude of the aircraft and/or the airport (e.g., terminal area speed limit). In some embodiments, the processor 110 is further operable to compare applicable operating constraints 122 associated with the aircraft and identify one of the applicable operating constraints 122 with the highest priority based on the aircraft's position. For example, a flight plan speed constraint associated with the aircraft's altitude (e.g., 250 kts below 10,000 ft) may be given a higher priority than a speed constraint at a waypoint 118.

In embodiments, the system 100 is operable to determine when the operating constraint(s) 122 corresponding to the applicable waypoints 118 function as limits on the target operating parameter(s) 120 associated with the aircraft. For example, the processor 110 is operable to compare an applicable operating constraint 122 with a target operating parameter 120 and determine if the operating constraint 122 functions as a limit on the target operating parameter 120. For example, if the target speed is 250 kts and the operating constraint 122 at the applicable waypoint 118 is BELOW 220 kts, the processor 110 is configured to identify that the operating constraint 122 functions as a limit on the target speed. Conversely, if the target speed is 220 kts and the operating constraint 122 at the applicable waypoint 118 is BELOW 250 kts, the processor is operable to identify that the operating constraint 122 does not function as a limit on the target speed.

Based on the comparison between the operating constraint 122 and the target operating parameter 120, the processor 110 is operable to display, via the graphical interface 104, an indication of the relationship between the target operating parameter 120 and the operating constraint 122 corresponding to the applicable waypoint 118. As described below, the processor 110 is operable to display a corresponding operating constraint indicator providing a visual indication of the limit on the target operating parameter 120 at the applicable waypoint 118. In some embodiments, the processor 110 is operable to provide an operating constraint indicator only when an operating constraint 122 associated with an applicable waypoint 118 has been identified. For example, if the processor 110 does not identify an operating constraint 122 associated with the applicable waypoint 118 and/or identifies a higher priority operating constraint 122 (e.g., an operating constraint associated with the position of the aircraft and/or the airport), the processor 110 will not display an operating constraint indicator associated with the applicable waypoint. In some embodiments, the processor 110 is operable to display real-time changes to the target operating parameter 120, applicable waypoint 118, and/or corresponding operating constraint 122. For example, the processor 110 may cause the graphical interface 104 to modify the operating constraint 122 and corresponding operating constraint indicator based on the next downstream waypoint 118. In such embodiments, the processor 110 is operable to display, via the graphical interface 104, a new operating constraint indicator to reflect changes in the applicable downstream waypoint 118. In some embodiments, the processor 110 may provide, via the graphical interface 104, additional visual and/or auditory indicators to show real-time changes in target operating parameters 120. For example, the processor 110 is operable to provide a second visual indicator (e.g., a flash of the target speed) to indicate a change in the target speed.

In a specific embodiment, the processor 110 is operable to display the operating constraint indicator only when the operating constraint 122 functions as a limit on the target operating parameter 120. For example, the operating constraint indicator will be displayed when the target speed is 250 kts and the operating constraint 122 at the applicable waypoint 118 is BELOW 220 kts. In such embodiments, the operating constraint indicator provides a visual indication to the operator that the target operating parameter 120 is governed by a flight plain operating constraint 122.

In some embodiments, the processor 110 is operable to display the operating constraint indicator in proximity to related primary flight information (e.g., airspeed indicator, altimeter, etc.) on the graphical interface 104. For example, a speed constraint indicator may be displayed in proximity to an airspeed indicator (e.g., speed tape) of the graphical interface 104, as described below.

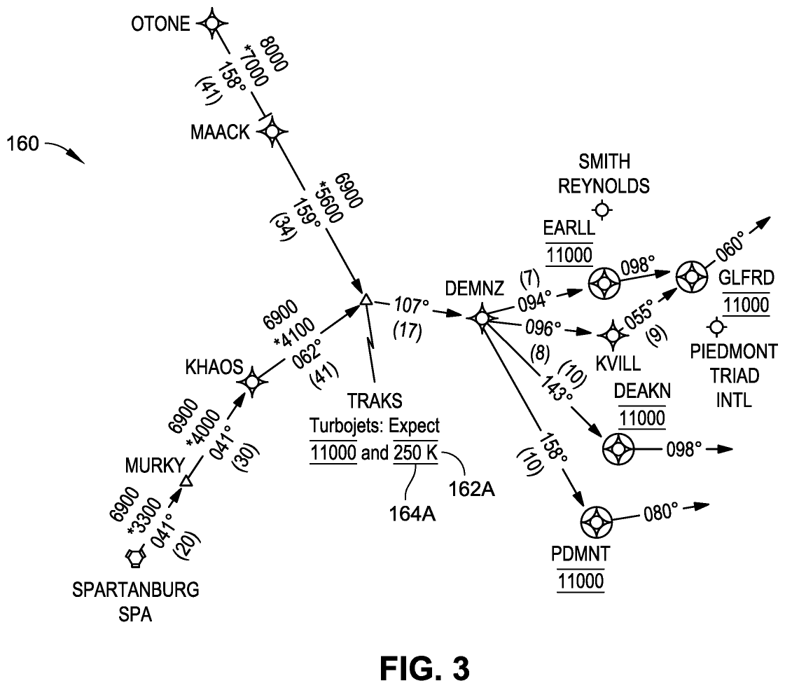

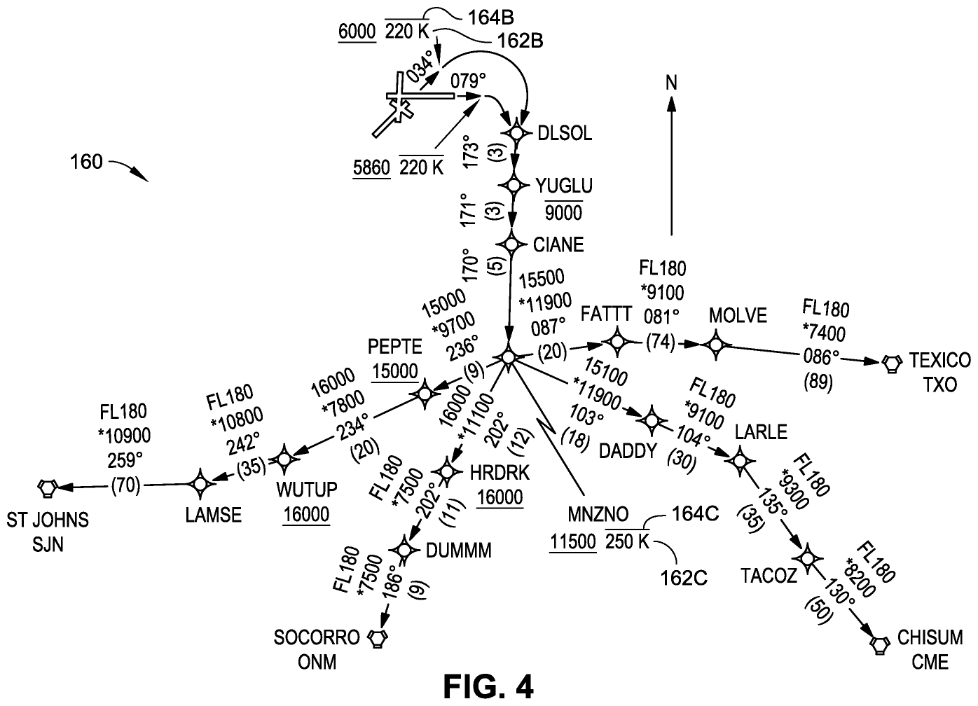

FIGS. 3 and 4 illustrate example flight charts 160 from which navigation data 116 may be obtained by the system 100. Each flight chart 160 includes operating information and waypoints (e.g., MNZNO; as described with reference to FIG. 4) associated with the approach. Each flight chart 160 also includes operating parameters 162A, 162B, 162C and corresponding operating constraints 164A, 164B, 164C associated with the waypoints and/or segments of the approach. As shown, an AT constraint (e.g., AT speed constraint 164A) is depicted with bars above and below the operating parameter (e.g., speed 162A). A BELOW constraint (e.g., BELOW speed constraint 164B, 164C) is depicted with a bar above the operating parameter (e.g., speed 162B, 162C). An ABOVE constraint (not shown) is depicted with a bar below the operating parameter. A BETWEEN constraint (not shown) is depicted by depicting the higher operating parameter directly above the lower operating parameter with bars above the higher operating parameter and below the lower operating parameter.

### Example Display Embodiments

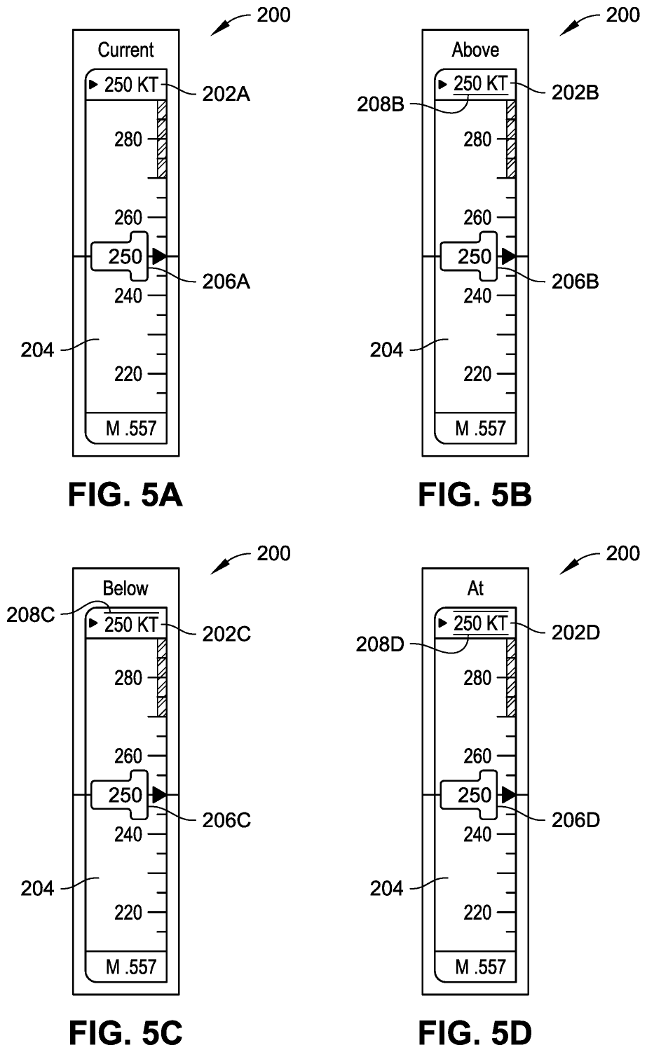

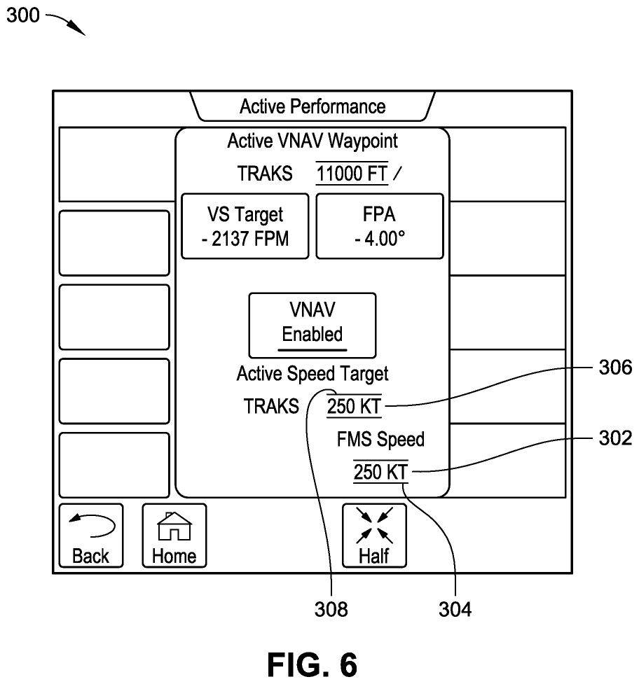

FIGS. 5A through 6 illustrate example displays 200, 300 furnishing flight information to the pilot via the graphical interface 104. For example, the display 200, 300 can include information related to the flight plan and/or flight charts.

Referring now to FIGS. 5A through 5B, the display 200 can include one or more target operating parameters (e.g., target speed 202A, 202B, 202C, 202D) arranged on the graphical interface 104. Based on identification of an applicable waypoint 118 (e.g., as described with reference to FIG. 1) and corresponding operating constraint 122, the processor 110 will populate the graphical interface 104 with a corresponding operating constraint indicator (e.g., speed constraint indicator 208B, 208C, 208D).

The operating constraint indicator 208B, 208C, 208D provides a visual indication of the restraint on the target operating parameter, such as an AT, ABOVE, BETWEEN, and/or BELOW constraint. In the case where BETWEEN is applicable, the visual indication can be either ABOVE or BELOW depending on which operating parameter of the BETWEEN constraint is restricting the target speed. As shown, an ABOVE operating constraint indicator (e.g., ABOVE speed constraint indicator 208B; as described with reference to FIG. 5B) is displayed with a speed bar below the target operating parameter (e.g., target speed 202B). A BELOW operating constraint indicator (e.g., BELOW speed constraint indicator 208C; as described with reference to FIG. 5C) is displayed with a speed bar above the target operating parameter (e.g., target speed 202C). An AT operating constraint indicator (e.g., AT speed constraint indicator 208D; as described with reference to FIG. 5D) is displayed with speed bars above and below the target operating parameter (e.g., target speed 202D). In embodiments, the operating constraint indicator 208B, 208C, 208D corresponds to the depiction of the operating constraint in the flight chart or flight plan at the applicable waypoint. For example, the AT speed constraint indicator 208D shown in FIG. 5D corresponds to the AT speed constraint 164A at the TRAKS waypoint of the flight chart 160 shown in FIG. 3.

It is contemplated that under certain conditions, no operating constraint indicator will be displayed (e.g., as described with reference to FIG. 5A). For example, if the processor 110 does not identify an operating constraint 122 corresponding to an applicable downstream waypoint 118 (e.g., as described above with reference to FIG. 1), or the operating constraint 122 does not function as a restraint on the target operating parameter 120 (e.g., the target operating parameter 120 lies within the boundaries of the operating constraint 122), the processor 110 will populate the display with the target operating parameter (e.g., target speed 202A), but will not include an operating constraint indicator. In such embodiments, the operating constraint indicator (or lack thereof) operates to inform the pilot of an inconsistency between the target operating parameter 120 and the operating constraint 122, for example, when the target operating parameter 120 is governed by an operating constraint 122. In some embodiments, when the processor 110 identifies a higher priority operating constraint 122 than an operating constraint 122 associated with the waypoint 118 (e.g., as described above with reference to FIG. 1), the processor 110 will not populate the display with an operating constraint indicator. For example, where the processor 110 determines that a flight plan speed constraint associated with the aircraft's altitude (e.g., 250 kts below 10,000 ft) or the airport (e.g., terminal area speed limit) is of higher priority than a speed constraint at a waypoint 118, no indicator for the speed constraint will be displayed. It is to be understood that while operating constraint indicators corresponding with flight plan waypoints are described herein, operating constraint indicators (e.g., bars or other visual indicators) may also be displayed for the other types of flight plan operating constraints described above (e.g., operating constraints associated with the aircraft's position and/or the airport).

As described above, the processor 110 is operable to display real-time changes to the applicable waypoint 118 and corresponding operating constraint 122. For example, the processor 110 can repopulate the display 200 with corresponding operating constraint indicators 208B, 208C, 208D as the applicable downstream waypoint 118 changes. In some embodiments, the processor 110 may populate the display 200 with additional visual indicators to show real-time changes in target operating parameters 202A, 202B, 202C, 202D. For example, the target speed 202A, 202B, 202C, 202D may flash to indicate a change in the target speed.

In some embodiments, the processor 110 is operable to display, via the graphical interface 104, the operating constraint indicator in proximity to related primary flight information on the graphical interface 104. For example, the speed constraint indicator 208B, 208C, 208D and/or target speed 202A, 202B, 202C, 202D may be displayed in proximity to an airspeed indicator (e.g., speed tape 204) of the display 200. In such embodiments, the displayed target speed 202A, 202B, 202C, 202D will correspond to the speed bug 206A, 206B, 206C, 206D of the speed tape 204. For example, the target speed 202A, 202B, 202C, 202D will correspond to the speed indicated at the speed bug's 206A, 206B, 206C, 206D position on the speed tape 204.

FIG. 6 illustrates another example display 300 furnishing target operating parameters 302, 306 and corresponding operating constraints 304, 308 to the pilot via the graphical interface 104. As shown, the target operating parameters 302, 306 and corresponding operating constraint indicators 304, 308 can be displayed in proximity to other primary flight information and/or selectable options (e.g., buttons).

It is to be understood that the displays 200, 300 can be configured to receive one or more types of pilot input via the control interface 106. In some embodiments, the display 200, 300 is configured for touch inputs (buttons, selectable menus, etc.) received via a touch surface. In other embodiments, pilot input can be received from other input devices (buttons, cursors, bezels, wheels, etc.) of the integrated avionics system 100. Additionally, features of the display 200, 300 of the graphical interface 104 and the other input devices can be configured based on the specifications of the aircraft to provide an accessible and user-friendly interface. It is to be further understood that the display 200, 300 can be configured to display information received from a variety of sources including, but not limited to: pilot input, data received from other aircraft systems, data received from aircraft instrumentation, data received from airport or ground systems/instrumentation, data received from aircraft or environmental sensors (e.g., airport sensors), data received via the aircraft communications system, and so forth.

It is to be understood that the terms “operator” and “pilot” are used interchangeably herein to describe any pilot, co-pilot, crew member, or other person who operates or controls the aircraft.

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

What is claimed is:

1. A flight deck system for an aircraft, the flight deck system comprising:
a processor;
a graphical interface for displaying flight-related information to a pilot;
a control interface for receiving information from the pilot and allowing the pilot to interact with the graphical interface;
a non-transitory computer-readable storage medium for storing a database related to the flight chart, the database including a plurality of waypoints and at least one speed constraint associated with the plurality of waypoints, the non-transitory computer-readable storage medium having computer executable instructions stored thereon for execution by the processor to:
receive, via the control interface, a target speed associated with the aircraft;
select, from the database, one of the plurality of waypoints and a corresponding one of the at least one speed constraint,
compare the target speed with the corresponding one of the at least one speed constraint, and
display, on the graphical interface, a speed constraint indicator based on the comparison of the target speed and the corresponding one of the at least one speed constraint, the speed constraint indicator displayed in proximity to an airspeed indicator of the graphical interface.

2. The flight deck system as recited in claim 1, wherein the computer executable instructions are configured to cause the graphical interface to display a visual indicator when the target speed changes from a first target speed to a second target speed.

3. The flight deck system as recited in claim 1, wherein the computer executable instructions are configured to cause the processor to identify a prioritization of applicable ones of the at least one speed constraint based on a position of the aircraft.

4. The flight deck system as recited in claim 3, wherein the computer executable instructions are further configured to cause the graphical interface to display the speed constraint indicator corresponding to the prioritized one of the at least one speed constraint.

5. The flight deck system as recited in claim 1, wherein the speed constraint indicator provides a visual indication of a discrepancy between the target speed and the corresponding one of the at least one speed constraint.

6. The flight deck system as recited in claim 1, wherein the speed constraint indicator includes at least one bar displayed in proximity to the airspeed indicator.

7. A flight deck system for an aircraft, the flight deck system comprising:
a processor;
a graphical interface for displaying flight-related information to a pilot, the flight-related information including operating criteria corresponding to a flight chart associated with an aircraft;
a control interface for receiving information from the pilot and allowing the pilot to interact with the graphical interface;
a non-transitory computer-readable storage medium for storing a database related to the flight chart, the database including a plurality of waypoints and at least one operating constraint associated with the plurality of waypoints, the non-transitory computer-readable storage medium having computer executable instructions stored thereon for execution by the processor to:
receive, via the control interface, a target operating parameter associated with the aircraft;
select, from the database, one of the plurality of waypoints and a corresponding one of the at least one operating constraint;
compare the target operating parameter with the corresponding one of the at least one operating constraint, and
display, on the graphical interface, an operating constraint indicator based on the comparison of the target operating parameter and the corresponding one of the at least one operating constraint.

8. The flight deck system as recited in claim 7, wherein the computer executable instructions are configured to cause the graphical interface to display a visual indicator when the target operating parameter changes from a first target operating parameter to a second target operating parameter.

9. The flight deck system as recited in claim 7, wherein the computer executable instructions are configured to cause the processor to identify a prioritization of applicable ones of the at least one operating constraint based on a position of the aircraft.

10. The flight deck system as recited in claim 9, wherein the computer executable instructions are further configured to cause the graphical interface to display the operating constraint indicator corresponding to the prioritized one of the at least one operating constraint.

11. The flight deck system as recited in claim 7, wherein the operating constraint indicator is displayed in proximity to an airspeed indicator of the graphical interface.

12. The flight deck system as recited in claim 11, wherein the operating constraint indicator includes at least one bar displayed in proximity to the airspeed indicator.

13. The flight deck system as recited in claim 7, wherein the target operating parameter is a target speed.

14. A method of operating a flight deck system of an aircraft, the flight deck system comprising a graphical interface for displaying flight-related information to a pilot, a control interface for receiving information from the pilot and allowing the pilot to interact with the graphical interface, and a non-transitory computer-readable storage medium for storing a database related to a flight chart associated with the aircraft, the method comprising:
receiving, via the control interface, a target operating parameter associated with the aircraft;
selecting, from the database, one of a plurality of waypoints associated with the flight chart and a corresponding one of at least one operating constraint associated with the plurality of waypoints;
comparing the target operating parameter with the corresponding one of the at least one operating constraint; and
displaying, via a graphical interface, an operating constraint indicator based on the comparison of the target operating parameter and the corresponding one of the at least one operating constraint.

15. The method as recited in claim 14, further comprising displaying, via the graphical interface, a visual indicator when the target operating parameter changes from a first target operating parameter to a second target operating parameter.

16. The flight deck system as recited in claim 14, further comprising identifying a prioritization of applicable ones of the at least one operating constraint based on a position of the aircraft.

17. The flight deck system as recited in claim 16, further comprising displaying, via the graphical interface, the operating constraint indicator corresponding to the prioritized one of the at least one operating constraint.

18. The method as recited in claim 14, wherein the operating constraint indicator is displayed in proximity to an airspeed indicator of the graphical interface.

19. The flight deck system as recited in claim 18, wherein the operating constraint indicator includes at least one bar displayed in proximity to the airspeed indicator.

20. The flight deck system as recited in claim 14, wherein the target operating parameter is a target speed.
